(19) United States
(12) Patent Application Publication
(10) Pub. No.: US 2006/0232750 A1
(43) Pub. Date: Oct. 19, 2006

(54) Optical member and illuminating device

(75) Inventor: Yoshihiro Yokote, Osaka (JP)

Correspondence Address: NDQ&M WATCHSTONE LLP, 1300 EYE STREET, NW, 400 EAST TOWER, WASHINGTON, DC, 20005, US

(73) Assignee: Sanyo Electric Co., Ltd., Moriguchi City. (JP)

(21) Appl. No.: 11/401,226

(22) Filed: Apr. 11, 2006

(30) Foreign Application Priority Data
Apr. 14, 2005 (JP) 2005-117609

(51) Int. Cl. G03B 21/14

(52) U.S. Cl. 353/20; 353/97

(57) ABSTRACT

There are provided an optical member, an illuminating device, and a projection type video display apparatus, capable of satisfying both or at least one of the following two functions. That is, one is to prevent light re-incident upon a reflective polarizer from becoming linearly polarized light having an undesirable polarization direction. The other is to improve exploiting efficiency of returned light. A reflection member and a ¼λ plate are disposed on the light entrance surface side of a rod integrator, and a reflective polarizer is disposed on the light exit surface side thereof. The reflection member is formed with a light transmission-use aperture, and an LED chip of the LED is positioned in the light transmission-use aperture. A mirror is formed at the rear surface of the LED chip, thereby eliminating occurrence of light leakage from the light transmission-use aperture. Furthermore, provision of the above-described ¼λ plate prevents the light re-incident upon the reflective polarizer from becoming linearly polarized light having an undesirable polarization direction.

### TECHNICAL FIELD

The present invention relates to an optical member and an illuminating device using the optical member.

### BACKGROUND ART

Conventionally, there have been used rod integrators with light integration effect, for preventing non-uniformity of light intensity distribution of a light source. In addition, as FIG. 11 shows, there have been proposed illuminating devices formed with a reflective polarizer 101 and a ¼λ plate 102 being disposed on the light exit surface side of a rod integrator 100, and a mirror 103 having a light transmission-use aperture 103a being disposed on the light entrance surface side thereof, thereby converting illumination light into linearly polarized light of a specific direction (see Japanese Patent Laying-open No. 2003-98597, Japanese Patent Laying-open No. 2005-25064).

However, in the above-described conventional art, shown in FIG. 10A, in a case that the ¼λ plate 102 is provided on the light exit surface side of the rod integrator 100, and circularly-polarized light, generated as a result of being reflected by the reflective polarizer 101 and passing through the ¼λ plate 102, is reflected for an odd number of times on the side surfaces of the rod integrator 100 before re-incidence upon the ¼ plate λ 102, the resultant light becomes linearly polarized light having an undesirable polarization direction when passing through the ¼λ plate 102. Therefore, there is a drawback that the polarization conversion capability is inferior. In addition, as shown in FIG. 10B, the light reflected by the reflective polarizer 101 leaks from the light transmission-use aperture 103a of the mirror 103, resulting in low exploiting efficiency of returned light (recycled light).

### DISCLOSURE OF THE INVENTION

In view of the above circumstances, an object of the present invention is to satisfy both or at least one of the following two functions. One is to prevent light re-incident upon a reflective polarizer from becoming linearly polarized light having an undesirable polarization direction. The other is to improve exploiting efficiency of returned light.

In order to solve the above problems, an optical member of the present invention comprises a rod integrator for integrating lights incident from a light entrance surface and allowing the incident light to exit from a light exit surface, a reflective polarizer for transmitting a specific linearly polarized light and reflecting the other polarized lights so as to be returned to an inside of the rod integrator, out of lights that exit from the light exit surface of the rod integrator, a reflecting means with aperture for transmitting light from a light transmission-use aperture, and reflecting the returning light that exits from the light entrance surface of the rod integrator by a plane or concave reflection surface so as to be re-incident upon the light entrance surface, and a ¼λ plate provided on a light entrance surface side of the rod integrator.

With the above structure, provision of the above-described ¼λ plate prevents the light re-incident upon the reflective polarizer from becoming linearly polarized light having an undesirable polarization direction. More specifically, in conventional structure (structure in which the ¼λ plate is provided on a light exit surface side of the rod integrator), reflected linearly-polarized light other than the specific linearly polarized light becomes circularly polarized light when passing through the ¼λ plate so as to become returned light. Since a rotation direction of a polarization of the circularly polarized light is reversed upon reflection, the circularly polarized light becomes the linearly polarized light other than the specific linearly polarized light after being reflected for an odd number of times and passing through the ¼λ plate. With the structure of the present application, the ¼λ plate is provided on the light entrance surface side of the rod integrator, and therefore, the above will not occur.

In the optical member according to the above structure, the ¼λ plate may be formed with the aperture being the same or approximately the same in position and size as the light transmission-use aperture.

In addition, an illuminating device of the present invention comprises any one of the above optical members, and a light source for irradiating light onto a light entrance surface of the rod integrator via the light transmission-use aperture (hereinafter, referred to as a first illuminating device in this section).

In the first illuminating device, the light source may be provided adjacent to the light transmission-use aperture. In addition, the light source may include a reflection means.

In the first illuminating device, it may be possible that the light source is formed with a lamp, and a converging means for converging emission light from the lamp by any one of reflection, refraction, and diffraction, and the light transmission-use aperture is disposed in a light converging area of emission light from the light source.

In addition, an illuminating device of the present invention comprises (a) an optical member including a rod integrator for integrating lights incident from a light entrance surface and allowing the incident lights to exit from a light exit surface, a reflective polarizer for transmitting a specific linearly polarized light, and reflecting the other polarized lights, out of lights that exit from the light exit surface of the rod integrator, and a ¼λ plate provided on the light exit surface side or the light entrance surface side of the rod integrator, and (b) a light source with a reflection surface having a reflection surface for reflecting light emitted from a light-emitting element so that the light is guided in an anterior direction, in which the light emitted from the light source with a reflection surface is incident upon the light entrance surface of the rod integrator, and returned light that exits from the light entrance surface of the rod integrator is reflected by the reflection surface of the light source with a reflection surface so that the returned light is once again guided to the light entrance surface of the rod integrator (hereinafter, referred to as a second illuminating device in this section).

With the above structure, the light source with a reflection surface does not include a light transmission-use aperture, so that it is possible to improve exploitation efficiency of the returned light.

In the second illuminating device, the reflection surface of the light source may be plane. In addition, in the second illuminating device, the reflection surface of the light source may be concave.

In these illuminating devices, the light source may be a color light source for emitting light of a certain color (hereinafter, referred to as a third illuminating device in this section). Or, in these illuminating devices, the light source may be a white light source (hereinafter, referred to as a fourth illuminating device in this section).

In addition, an illuminating device of the present invention comprises a third illuminating device for emitting light of a first color, a third illuminating device for emitting light of a second color, a third illuminating device for emitting light of a third color, and an optical member for transmitting light of each color from each illuminating device in approximately the same direction. In such the structure, it is possible that the light of a first color is red, the light of a second color is blue, and the light of a third color is green (hereinafter, referred to as a fifth illuminating device in this section). In addition, in the fifth illuminating device, it may be configured such that red light, blue light, and green light are continuously emitted during illumination (hereinafter, referred to as a sixth illuminating device in this section). Or, in the fifth illuminating device, it may be configured such that red light, blue light, and green light are emitted in a time-sequential manner during illumination (hereinafter, referred to as a seventh illuminating device in this section).

Furthermore, a projection type video display apparatus may be formed of the third illuminating device for emitting red light, the third illuminating device for emitting blue light, the third illuminating device for emitting green light, light valves each provided for receiving light of each color from each illuminating device, and a projection means for mixing and projecting image light of each color obtained via each light valve.

In addition, the projection type video display may be formed of the fourth illuminating device or the sixth illuminating device, one full-color light valve, and a projection means for projecting image light obtained via the full-color light valve.

Furthermore, the projection type video display may be formed of the fourth illuminating device or the six illuminating device, a separation means for separating white color light emitted from the illuminating device into red light, green light, and blue light, light valves each provided for receiving light of each color, and a projection means for mixing and projecting image light of each color obtained via each light valve.

In addition, the projection type video display may be formed of the seventh illuminating device, one light valve, means for supplying a video signal of each color to the light valve in synchronization with emission timing of light of each color, and a projection means for projecting image light obtained via the light valve.

According to the present invention, it is possible to prevent light re-incident upon a reflective polarizer from becoming linearly polarized light having an undesirable polarization direction, and in addition, to improve exploiting efficiency of returned light.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a descriptive diagram showing three-panel projection type video display apparatuses provided with optical members (illuminating devices) of the present invention;

FIG. 2A is a descriptive diagram showing the optical member (illuminating device) of FIG. 1;

FIG. 2B is a descriptive diagram showing structure in which a tapered rod, which replaces a rod in the structure of FIG. 2A, is adopted;

FIG. 3 is a descriptive diagram showing another optical member (illuminating device) of the present invention;

FIG. 4 is a descriptive diagram showing a single panel projection type video display apparatus provided with another optical member (illuminating device) of the present invention;

FIG. 5 is a descriptive diagram showing a single panel projection type video display apparatus provided with another optical member (illuminating device) of the present invention;

FIGS. 6A, 6B, and 6C are descriptive diagrams each of which shows another optical member (illuminating device) of the present invention;

FIGS. 7A, 7B are descriptive diagrams each of which shows another optical member (illuminating device) of the present invention;

FIGS. 8A, 8B are descriptive diagrams each of which shows another optical member (illuminating device) of the present invention;

FIG. 9 is a descriptive diagram showing a three panel projection type video display apparatus provided with the optical members (illuminating devices) of the present invention;

FIGS. 10A, 10B are descriptive diagrams for describing drawbacks of the prior art; and

FIG. 11 is a perspective view showing a rod integrator provided with a conventional polarization conversion function.

### DESCRIPTION OF THE PREFERRED EMBODIMENT

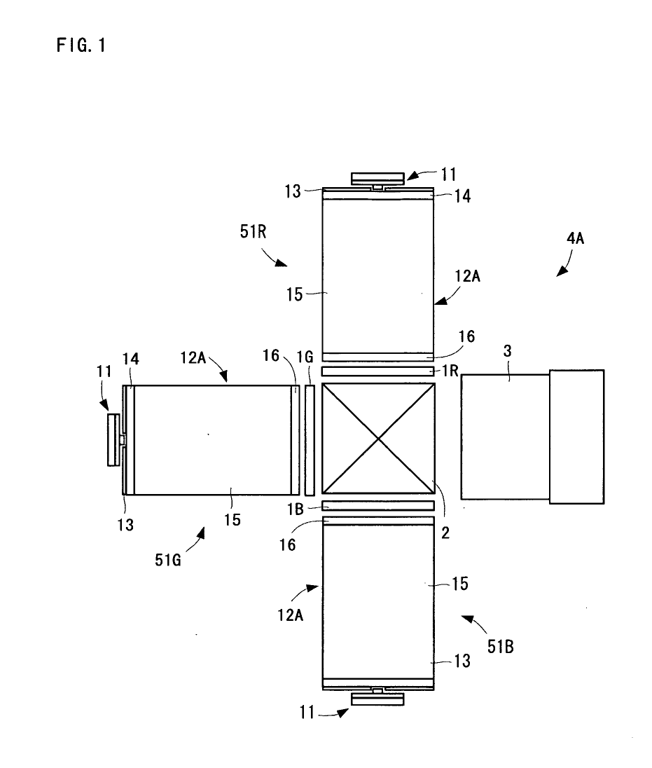

Hereinafter, embodiments of the present invention will be described based on FIG. 1 to FIG. 9.

FIG. 1 shows an optical system of a projection type video display apparatus 4A. The projection type video display apparatus 4A is provided with three illuminating devices 51R, 51G and 51B (hereinafter, a numeral “51” is used for generally referring to the illuminating device). Each illuminating device 51 is constructed of an LED (light emitting diode) 11, and an optical member 12A. The illuminating device 51R emits red light, the illuminating device 51G emits green light, and the illuminating device 51B emits blue light.

The LED 11 is constructed of an LED chip, an LED substrate, and a heat sink. The LED 11 in the illuminating device 51R emits red light, the LED 11 in the illuminating device 51G emits green light, and the LED 11 in the illuminating device 51B emits blue light.

The optical member 12A performs light integration so that intensity of the light emitted from the LED 11 is rendered uniform on the surface of an object to be illuminated (liquid crystal display panel, for example). Furthermore, the optical member 12A includes operation for converting emission light into linearly polarized light of a specific direction. The shape of a light exit surface of the optical member 12A is equal to or approximately equal to that of a liquid crystal display panel 1. Detailed structure of the optical member 12A will be described later.

A liquid crystal drive signal (video signal) for each color is applied to each liquid crystal display panel 1R, 1B, and 1G from a driver not shown. Each image light of each color modulated as a result of passing through each liquid crystal display panel 1 is mixed by a cross dichroic prism 2 so as to become full-color image light. This full-color image light is projected by a projection lens 3, and displayed on a screen not shown.

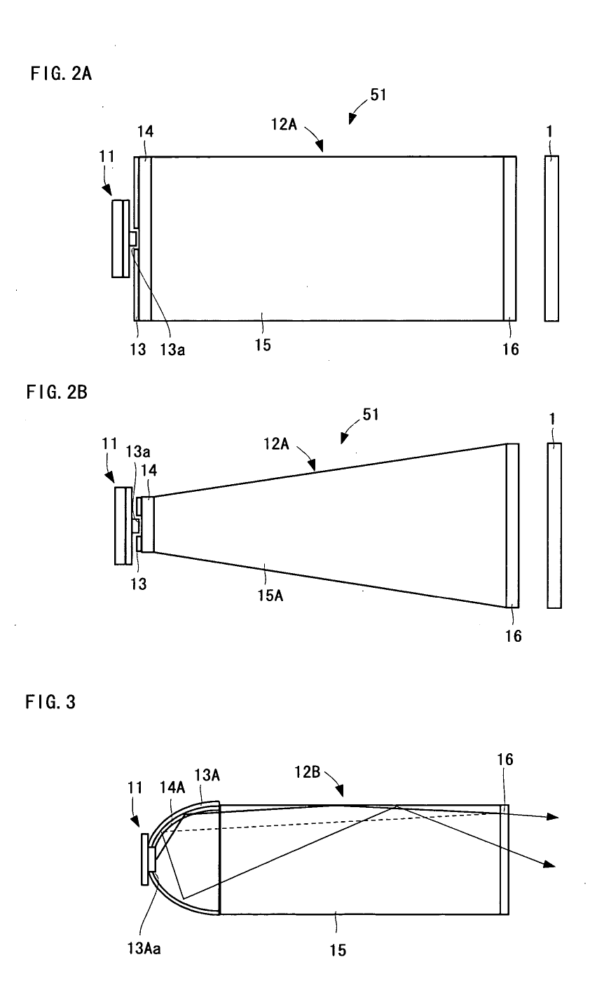

As shown in FIG. 2A, the optical member 12A is constructed of a rod integrator 15, a reflective polarizer 16 provided on the light exit surface side of the rod integrator 15, a reflection member 13 provided on the light entrance surface side of the rod integrator 15, and a ¼λ plate 14 provided between the reflection member 13 and the light entrance surface. The reflection member 13 is constructed of a metal mirror or a dielectric multilayer film, for example. The reflection member 13 is provided with a light transmission-use aperture 13a, and the light emission portion of the LED 11 is arranged in this light transmission-use aperture 13a. The LED chip may emit light in approximately all directions ahead thereof, for example. In addition, the LED chip is arranged so that an air gap is formed between the light entrance surface (flat surface) and the LED chip. Furthermore, the LED chip is provided with a mirror (hereinafter, referred to as an LED rear surface mirror) for guiding emitting light of the LED chip in an anterior direction. This mirror is a metal mirror, for example.

The reflective polarizer 16 is a so-called wire grid, and in this embodiment, the reflective polarizer 16 transmits S-polarized light as desired polarized light, and reflects P-polarized light (see the cited documents listed in the Background Art), for example. Needless to say, a reflection-to-transmission relationship between the S-polarize light and the P-polarized light may be reversed, that is, the reflective polarizer 16 may reflect the S-polarized light and transmit the P-polarized light. The P-polarized light reflected by the reflective polarizer 16 becomes circularly polarized light as a result of passing through the ¼λ plate 14. The circularly polarized light is reflected by the reflection member 13, and passes through the ¼λ plate 14 once again. The resultant light becomes the S-polarized light. The S-polarized light passes through the reflective polarizer 16 and exits from the rod integrator 15. The shape of the rod integrator 15 is rectangular parallelepiped, however not limited thereto. In addition, the rod integrator 15 may have hollow structure of which inner surface is reflective, or may have non-hollow structure formed of a transparent member (transparent glass, for example).

It is noted that in each illuminating device 51, a plural number of LEDs 11 may be provided. In this case, a plurality of light transmission-use apertures 13a for guiding the emission light from each LED chip are formed. In the optical member 12A, a tapered rod integrator 15A may be used for the rod integrator 15, as shown in FIG. 2B. The size of the light exit surface of the rod integrator 15A is larger than that of the light entrance surface. As a result of using the rod integrator 15A, light with a low diffusion angle is guided to the light exit surface of the rod integrator 15A. When the light with a low diffusion angle is guided to the light exit surface, transmission efficiency of desired polarized light in the reflective polarizer 16 improves. Instead of the rod integrator 15, the rod integrator 15A can be used in other configurations.

With the illuminating device 51 provided with the above optical member 12A, as described above, the P-polarized light reflected by the reflective polarizer 16 passes through the ¼λ plate 14, and the resultant light becomes the circularly polarized light. The circularly polarized light is reflected by the reflection member 13, and passes through the ¼λ plate 14 once again. The resultant light becomes the S-polarized light. The S-polarized light passes through the reflective polarizer 16, and exits from the rod integrator 15. That is, it is possible to prevent the light re-incident upon the reflective polarizer 16 from becoming linearly polarized light having an undesirable polarization direction. In addition, the LED 11 is provided so that the light transmission-use aperture 13a is shielded, and the returned light is reflected by the rear surface mirror of the LED 11, thereby improving exploiting efficiency of the returned light.

FIG. 3 is a descriptive diagram showing an illuminating device constructed of the LED 11 and an optical member 12B. The optical member 12B is constructed of the rod integrator 15, and a reflection member 13A and a ¼λ plate 14A provided on the light entrance surface side of the rod integrator 15. The reflection member 13A and the ¼λ plate 14A are located separate from the light entrance surface of the rod integrator 15, and are concave in shape (a concave curved surface in shape, or a concave polyhedral surface in shape). In this embodiment, the ¼λ plate 14A is formed in an area half the reflection member 13A (the area which corresponds to a half the circumference of the reflection member 13A). The reflection member 13A is formed with a light transmission-use aperture 13Aa. The light emission portion of the LED 11 is arranged in the light transmission-use aperture 13Aa. As the reflection member 13A, a parabolic reflector can be used, for example. The ¼λ plate 14A may be adhered to the reflection surface of the parabolic reflector. It is noted that instead of the concave ¼λ plate 14A, a plane ¼λ plate 14 may be disposed on the light entrance surface of the rod integrator 15.

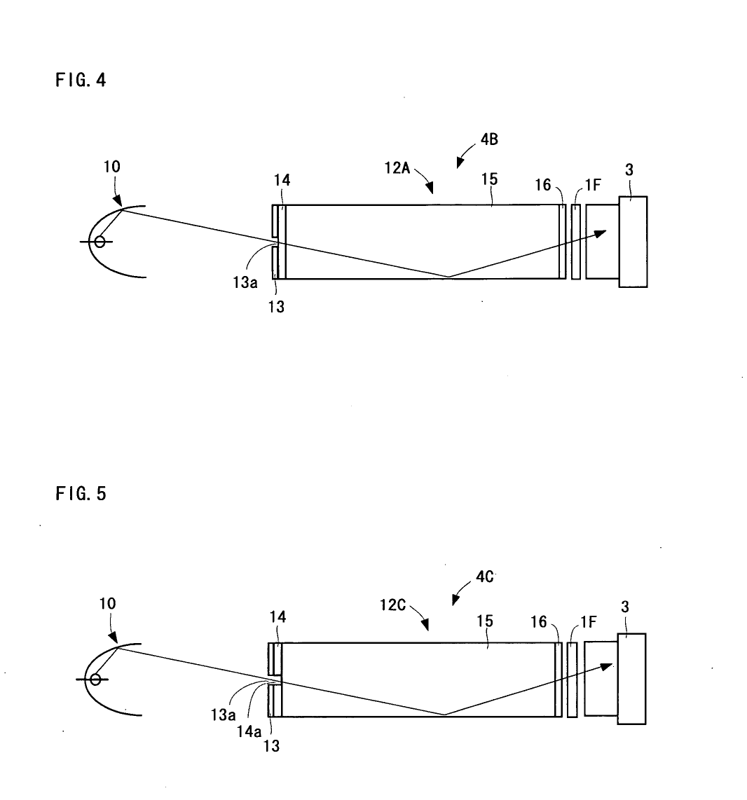

FIG. 4 is a descriptive diagram showing a projection type video display apparatus 4B. An illuminating device of the projection type video display apparatus 4B is constructed of a light source 10 and the optical member 12A. The light source 10 is constructed of a lamp such as an ultra-high pressure mercury lamp, a metal halide lamp, a xenon lamp, etc., and an elliptic reflector for converging irradiating light of the lamps. It is noted that instead of using the elliptic reflector, the light source 10 may be provided with a parabolic reflector for collimating the irradiating light, and a lens for converging the collimated light from this parabolic reflector. The converging position of the light emitted from the light source 10 corresponds to the forming position of the light transmission-use aperture 13a. On the light exit side of the optical member 12A, a full-color, transmissive liquid crystal display panel 1F and a projection lens 3 are provided. In such the configuration, too, it is possible to prevent the light re-incident upon the reflective polarizer 16 from becoming the linearly polarized light having an undesired polarization direction.

FIG. 5 is a descriptive diagram showing a projection type video display apparatus 4C. An illuminating device of the projection type video display apparatus 4C is constructed of the light source 10 and an optical member 12C. The optical member 12C, which has structure approximately similar to that of the optical member 12A, is different from the optical member 12A in that an aperture 14a is formed in the ¼λ plate 14. The forming position of the aperture 14a corresponds to that of the light transmission-use aperture 13a. It is noted that in a case of guiding from an oblique direction the light from the light source 10 to the light transmission-use aperture 13a, the aperture 14a may be formed to be slightly displaced from the light transmission-use aperture 13a. In addition, in a case of providing a plurality of light sources 10 and a case of guiding from the oblique direction the light from each light source 10 to the light transmission-use aperture 13a, the aperture 14a may be larger in some degree than the light transmission-use aperture 13a. On the light exit side of the optical member 12C, the full-color, transmissive liquid crystal display panel 1F and the projection lens 3 are provided.

It is noted that in the configurations shown in FIGS. 4 and 5, instead of the light source 10, an LED for emitting white light may be provided. The LED is disposed in the light transmission-use aperture 13a. Furthermore, in a case that the LED includes the LED rear surface mirror, exploiting efficiency of the returned light is improved.

In addition, in the configuration shown in FIG. 3, the light source 10 may be provided instead of the LED 11. In this configuration, the light from the light source 10 is converged toward the light transmission-use aperture 13Aa, and thereafter, diverged and guided to the light entrance surface of the rod integrator 15. In addition, in such the configuration, the plane ¼λ plate 14 may be disposed on the light entrance surface. In this case, the light diverged via the light transmission-use aperture 13Aa is irradiated onto the plane ¼λ plate 14, thereby almost eliminating adverse effect caused by the light from the light source 10 onto the plane ¼λ plate 14.

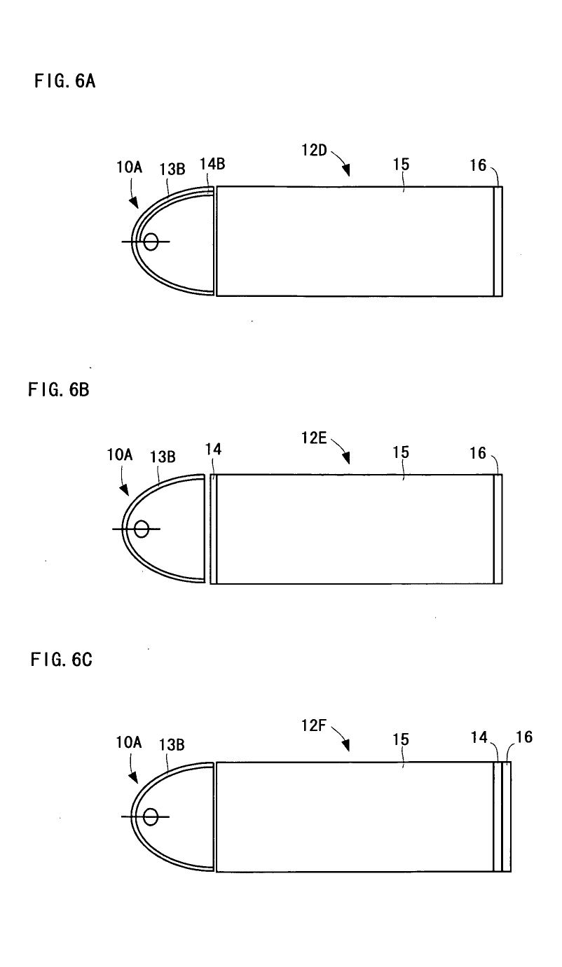

Illuminating devices shown in FIGS. 6 to 8 are configuration examples without the reflection member 13 (13A) having a light transmission-use aperture. In these configurations, the reflection surface with which the light source by itself is formed is used for reflecting the returned light, and the illuminating devices are not provided with the light transmission-use aperture. This improves the exploiting efficiency of the returned light. Regarding polarization conversion, although it is desirable to adopt a configuration capable of preventing the light re-incident upon the reflective polarizer 16 from becoming the linearly polarized light having an undesired polarization direction, it is not necessary to adopt such the configuration.

FIG. 6A is a descriptive diagram showing an illuminating device constructed of a light source 10A and an optical member 12D. The light source 10A includes a lamp and a parabolic reflector 13B, and is formed with a ¼λ plate 14B adhered to the reflection surface of the parabolic reflector 13B. A light emitting element of the light source 10A is not limited to a lamp, and may be a solid light emitting element. The parabolic reflector 13B and the ¼λ plate 14B do not have the light transmission-use aperture. The optical member 12D is provided with the reflective polarizer 16 on the light exit surface of the rod integrator 15. The light source 10A is disposed so that the light emission aperture thereof faces the light entrance surface of the rod integrator 15. The shape of the light emission aperture may be equal to or approximately equal to that of the light entrance surface of the rod integrator 15. It is noted that as shown in FIG. 6B, it may be possible to use an optical member 12E in which the plane ¼λ plate 14, instead of the above ¼λ plate 14A, is disposed on the light entrance surface of the rod integrator 15. In addition, as shown in FIG. 6C, it may be possible to use an optical member 12F in which the plane ¼λ plate 14 is disposed between the reflective polarizer 16 and the light exit surface of the rod integrator 15.

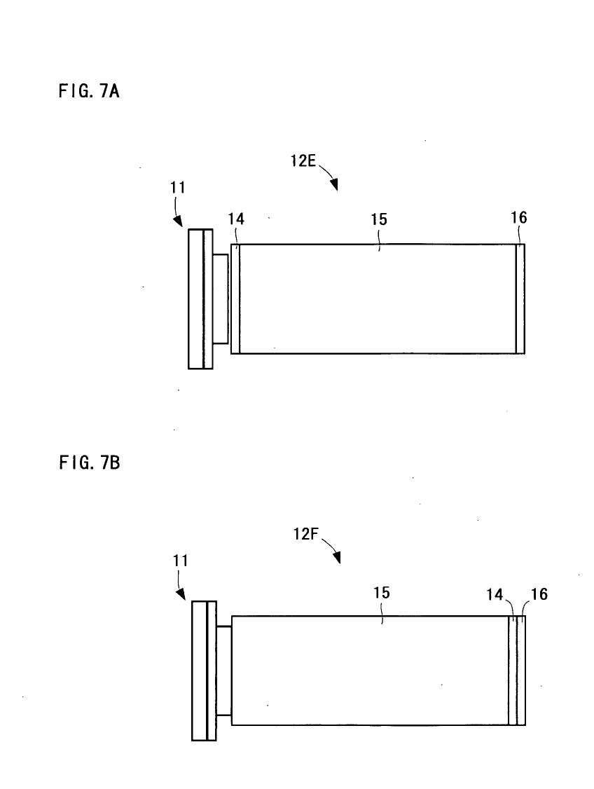

FIG. 7A is a descriptive diagram showing an illuminating device constructed of the LED 11 and the optical member 12E. The size of the light exit surface of the LED 11 (size of the LED rear surface mirror) is the same or approximately the same as (dimensional approximation of 90 percent or more, for example) that of the light entrance surface of the rod integrator 15, and all or almost all of the light entrance surface of the rod integrator 15 is covered with the LED rear surface mirror. If the shape of the light entrance surface of the rod integrator 15 is quadrangle, that of the light exit surface of the LED 11, too, may be quadrangle.

FIG. 7B shows a descriptive diagram showing an illuminating device constructed of the LED 11 and the optical member 12F. The size of the light exit surface of the LED 11 (size of the LED rear surface mirror) is the same or approximately the same as (dimensional approximation of 90 percent or more, for example) that of the light entrance surface of the rod integrator 15, and all or almost all of the light entrance surface of the rod integrator 15 is covered with the LED rear surface mirror. If the shape of the light entrance surface of the rod integrator 15 is quadrangle, that of the light exit surface of the LED 11, too, may be quadrangle.

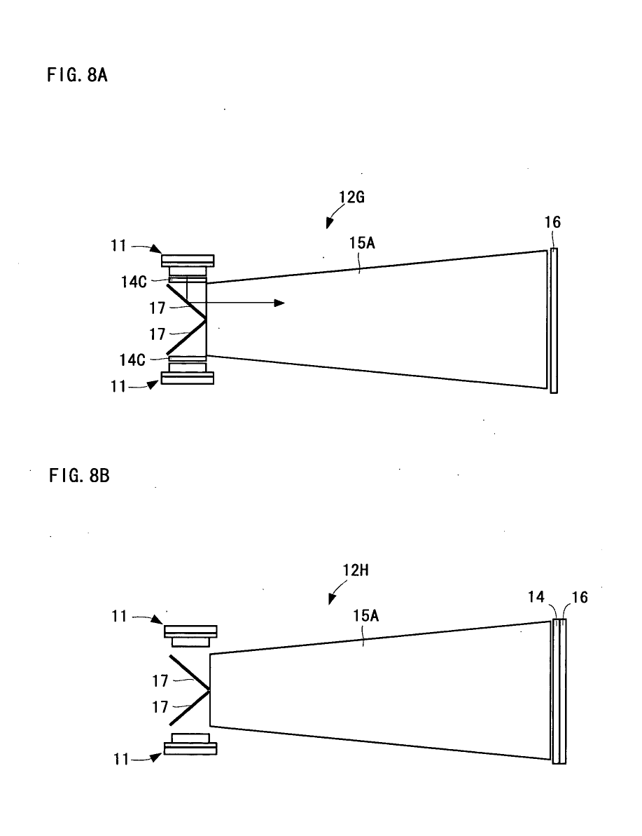

FIG. 8A is a descriptive diagram showing an illuminating device constructed of the two LEDs 11 and an optical member 12G. The optical member 12G is provided with the tapered rod integrator 15A of which light exit surface is larger than the light entrance surface. On the light exit surface of the rod integrator 15A, the reflective polarizer 16 is arranged. The two LEDs 11, 11 have the primary optical axes perpendicular to the center axis of the rod integrator 15A, and are disposed adjacent to the light entrance surface of the rod integrator 15A. On the light emission side of each LED 11, a ¼λ plate 14C is disposed. The returned light that exits from the light entrance surface of the rod integrator 15A is reflected by each of mirrors 17, and passes through the ¼λ plate 14C. This is followed by being reflected by the LED rear surface mirror of the LED 11. The resultant light passes through the ¼λ plate 14C once again. Thereafter, the resultant light is reflected by the mirror 17, and is incident upon the light entrance surface of the rod integrator 15A.

FIG. 8B is a descriptive diagram showing an illuminating device constructed of the two LEDs 11 and an optical member 12H. The optical member 12H is provided with the tapered rod integrator 15A of which light exit surface is larger than the light entrance surface. On the light exit surface of the rod integrator 15A, the reflective polarizer 16 is disposed. The two LEDs 11, 11 have the primary optical axes perpendicular to the center axis of the rod integrator 15A, and are disposed adjacent to the light entrance surface of the rod integrator 15A. Each light emitted from the two LEDs 11, 11 is reflected by each of the mirrors 17, and guided to the light entrance surface of the rod integrator 15A. The returned light that exits from the light entrance surface of the rod integrator 15A is reflected in the order of the mirror 17, the LED rear surface mirror of the LED 11, and the mirror 17, and is incident upon the light entrance surface of the rod integrator 15A. Thereafter, the resultant light reaches the ¼λ plate 14.

In these configurations in FIGS. 8A and 8B, it is possible to adopt a configuration in which a larger number of LEDs are provided.

In addition, an illuminating device X may be adopted. This illuminating device is provided with the illuminating devices (51R, 51G and 51B) for emitting light of each color, shown in FIG. 1, in which the light of each color (red light, blue light, and green light) from these illuminating devices are guided by a cross dichroic prism or a cross dichroic mirror in the same direction, for example. An illuminating device configured as such can be adopted. Needless to say, another illuminating device or optical member of the present invention may be used for the illuminating device for each color. A liquid crystal display panel used in the projection type video display apparatus using the illuminating device for guiding the light of each color in the same direction has structure with RGB color filters, or has structure without the RGB color filters. In a case of using the liquid crystal display panel of the structure with the RGB color filters, all illuminating devices are simultaneously illuminated, and white light is guided to the liquid crystal display panel. In a case of using the liquid crystal display panel of the structure without the RGB color filters, each illuminating device is illuminated in a time-sequential manner for a predetermined time period, and in synchronization of timing of illuminating for the predetermined time period, a video signal of each color is applied to the liquid crystal display panel.

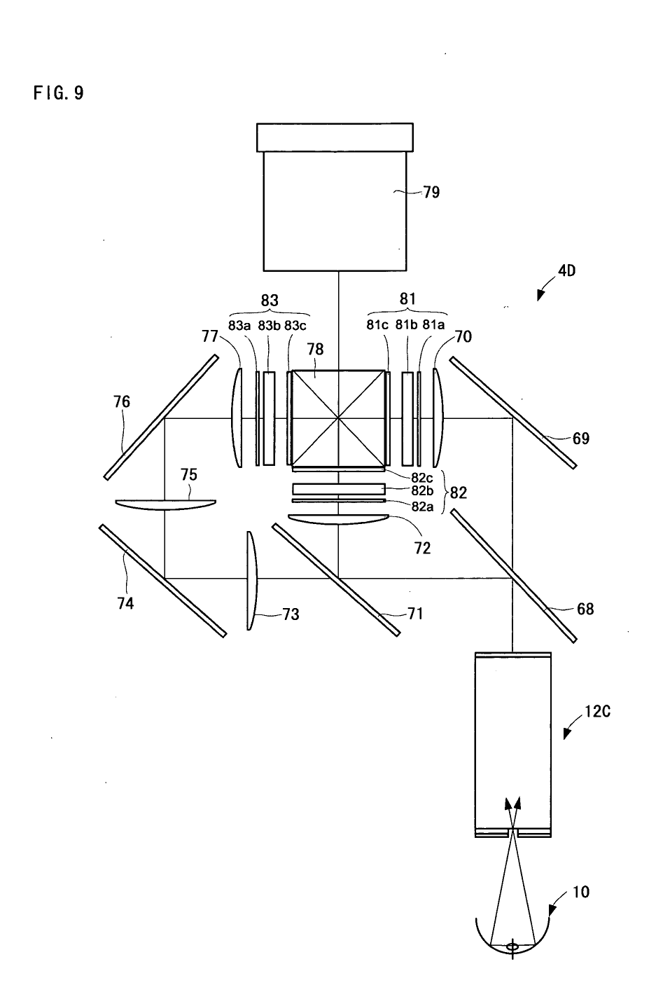

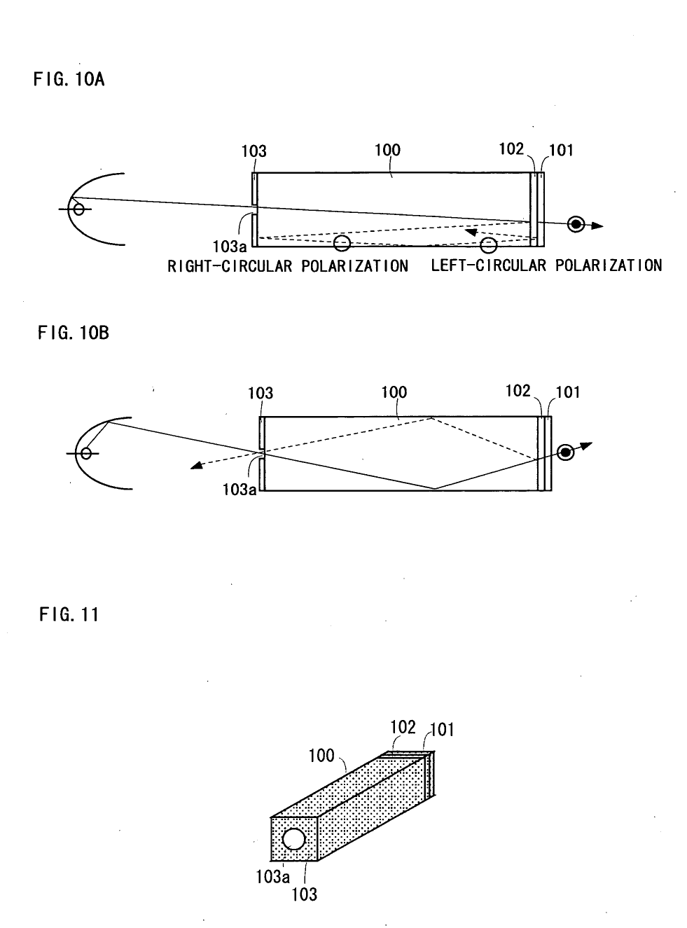

FIG. 9 is a descriptive diagram showing a three-panel projection type video display apparatus 4D. The projection type video display apparatus 4D is provided with, for example, the optical member 12C and the light source 10 shown in FIG. 5. Needless to say, instead of the optical member 12C and the light source 10, the projection type video display apparatus 4D may be provided with another illuminating device or optical member of the present invention. White light emitted from the light source 10 is incident upon the optical member 12C, and the polarization direction of the white light is directed in a common direction, thereby the white light is optically integrated. Thereafter, the white light exits from the optical member 12C. The white light that exits from the optical member 12C is guided to a first dichroic mirror 68. The first dichroic mirror 68 transmits light in a red wavelength band, and reflects light in a cyan (green+blue) wavelength band. The light in a red wavelength band passing through the first dichroic mirror 68 is reflected by a reflection mirror 69, thereby the optical path of the light is changed. The red light reflected by the reflection mirror 69 passes through a transmissive liquid crystal display panel 81 for red light via a condenser lens 70, thereby the red light is optically modulated. On the other hand, the light in a cyan wavelength band reflected by the first dichroic mirror 68 is guided to a second dichroic mirror 71.

The second dichroic mirror 71 transmits the light in a blue wavelength band, and reflects the light in a green wavelength band. The light in a green wavelength band reflected by the second dichroic mirror 71 is guided to a transmissive liquid crystal display panel 82 for green light via a condenser lens 72. As a result of passing therethrough, the light is optically modulated. In addition, the light in a blue wavelength band passing through the second dichroic mirror 71 is guided to a transmissive liquid crystal display panel 83 for blue light via reflection mirrors 74, 76, relay lenses 73, 75, and a condenser lens 77. As a result of passing through the transmissive liquid crystal display panel 83, the light is optically modulated.

The respective liquid crystal display panel 81, 82, and 83 are constructed of incidence side polarizers 81a, 82a, and 83a, panel portions 81b, 82b, and 83b formed by sealing liquid crystal between one pair of glass plates (on which pixel electrodes and alignment films are formed), and light emission side polarizers 81c, 82c, and 83c. Each modulated light (image light of each color) modulated via the liquid crystal display panels 81, 82, and 83 is mixed by a cross dichroic prism 78, thereby the resultant light becomes color image light. The color image light is projected by a projection lens 79, and displayed on a screen.

In the above descriptions, although the projection type video display apparatus (rear projection type or front projection type) uses the transmissive liquid crystal display panel, this is not always the case. A reflective liquid crystal display panel may be used. In addition, instead of these liquid crystal display panels, a display panel for individually driving a multiple of micro mirrors serving as dots may be used.

In addition, in the illuminating devices described above, a projection-use curved surface mirror may be used instead of the projection lens. Furthermore, as the solid light emitting element, besides the LED, an organic or inorganic EL (electroluminescence), etc., may be used.

Although the present invention has been described in detail by the use of illustration, the present invention is merely described by the use of Figures and examples, and thus, it is obvious that the present invention is not limited thereto. The spirit and the scope of the present invention are limited only by the terms in the attached claims.

What is claimed is:

1. An optical member, comprising:
a rod integrator for integrating lights incident from a light entrance surface and allowing the incident light to exit from a light exit surface;
a reflective polarizer for transmitting a specific linearly polarized light, and reflecting the other polarized lights so as to be returned to an inside of the rod integrator, out of lights that exit from a light exit surface of the rod integrator;
a reflecting means with aperture for transmitting light from a light transmission-use aperture, and reflecting the returning light that exits from the light entrance surface of the rod integrator by a plane or concave reflection surface so as to be re-incident upon the light entrance surface; and
a ¼λ plate provided on the light entrance surface side of the rod integrator.

2. An optical member according to claim 1, wherein the ¼λ plate is formed with the aperture being the same or approximately the same in position and size as the light transmission-use aperture.

3. An illuminating device, comprising:
the optical member according to claim 1; and
a light source for irradiating light onto a light entrance surface of the rod integrator via the light transmission-use aperture.

4. An illuminating device according to claim 3, wherein the light source is provided adjacent to the light transmission-use aperture.

5. An illuminating device according to claim 3, wherein the light source includes a reflection means.

6. An illuminating device according to claim 3, wherein the light source is formed with a lamp, and a converging means for converging emission light from the lamp by any one of reflection, refraction, and diffraction, and the light transmission-use aperture is disposed in a light converging area of emission light from the light source.

7. An illuminating device, comprising:
(a) an optical member including:
a rod integrator for integrating lights incident from a light entrance surface and allowing the incident lights to exit from a light exit surface;
a reflective polarizer for transmitting a specific linearly polarized light, and reflecting the other polarized lights, out of lights that exits from the light exit surface of the rod integrator; and
a ¼λ plate provided on a light exit surface side or a light entrance surface side of the rod integrator, and
(b) a light source with a reflection surface having a reflection surface for reflecting light emitted from a light-emitting element so that the light is guided in an anterior direction, wherein
the light emitted from the light source with a reflection surface is incident upon the light entrance surface of the rod integrator, and returned light that exits from the light entrance surface of the rod integrator is reflected by the reflection surface of the light source with a reflection surface so that the returned light is once again guided to the light entrance surface of the rod integrator.

8. An illuminating device according to claim 3, wherein the light source is a color light source for emitting light of a certain color.

9. An illuminating device according to claim 7, wherein the light source is a color light source for emitting light of a certain color.

10. An illuminating device according to claim 3, wherein the light source is a white light source.

11. An illuminating device according to claim 7, wherein the light source is a white light source.

12. An illuminating device, comprising:
the illuminating device according to claim 8 for emitting light of a first color;
the illuminating device according to claim 8 for emitting light of a second color;
the illuminating device according to claim 8 for emitting light of a third color; and
an optical member for transmitting light of each color from each illuminating device in approximately the same direction.

13. An illuminating device, comprising:
the illuminating device according to claim 9 for emitting light of a first color;
the illuminating device according to claim 9 for emitting light of a second color;
the illuminating device according to claim 9 for emitting light of a third color; and
an optical member for transmitting light of each color from each illuminating device in approximately the same direction.

14. An optical member according to claim 1, wherein the light exit surface of the rod integrator is larger than the light entrance surface.

15. An illuminating device according to claim 7, wherein the light exit surface of the rod integrator is larger than the light entrance surface.
